(19) United States
(12) Patent Application Publication
(10) Pub. No.: US 2017/0273327 A1
(43) Pub. Date: Sep. 28, 2017

(54) CONTINUOUS PROCESS FOR PREPARING A LIQUID NUTRITIONAL PRODUCT

(71) Applicant: ABBOTT LABORATORIES, Abbott Park, IL (US)

(72) Inventors: TIMOTHY LAPLANTE, Powell, OH (US); GUL KONUKLAR, New Albany, OH (US); MATTHEW ROBERTS, Powell, OH (US)

(73) Assignee: ABBOTT LABORATORIES, Abbott Park, IL (US)

(21) Appl. No.: 15/514,040

(22) PCT Filed: Sep. 25, 2015
(86) PCT No.: PCT/US2015/052251

§ 371 Date: Mar. 24, 2017

Related U.S. Application Data
(60) Provisional application No. 62/055,845, filed on Sep. 26, 2014.

(51) Int. Cl. A23C 9/15; A23L 33/00; A23L 33/125; A23L 33/17; A23L 33/115; A23L 2/385; A23P 30/25

(52) U.S. Cl. CPC A23C 9/15; A23L 2/385; A23L 33/40; A23P 30/25; A23L 33/17; A23L 33/115; A23L 33/125; A23V 2002/00

(57) ABSTRACT

A continuous process for preparing a liquid nutritional product using an extruder is provided. A powder nutritional component is fed into an inlet of an extruder, and a liquid component is fed into an inlet of the extruder. The powder nutritional component and the liquid component are mixed within the extruder to form an intermediate nutritional blend. The intermediate nutritional blend is hydrated to form a liquid nutritional product.

### CROSS-REFERENCE TO RELATED APPLICATIONS

This application claims priority to and the benefit of U.S. Provisional Patent Application No. 62/055,845, filed Sep. 26, 2014, the entire contents of which are incorporated by reference herein.

### FIELD

The present disclosure relates to processes for preparing liquid nutritional products. More particularly, the present disclosure relates to a continuous process for preparing a liquid nutritional product using an extruder.

### BACKGROUND

Conventional processes for manufacturing liquid nutritional products, such as nutritional emulsions, generally include the preparation of multiple slurries that are subsequently combined to form the liquid nutritional product. For example, in a typical process for preparing a nutritional emulsion, a protein slurry, a carbohydrate slurry, and an oil blend are separately prepared. Once prepared, the protein slurry, the carbohydrate slurry, and the oil blend are blended together and typically undergo further processing steps such as homogenization and sterilization to produce the final nutritional emulsion. Such processes tend to lack efficiency from an energy and cycle time perspective and increase the cost of producing the liquid nutritional products.

### SUMMARY

Disclosed herein is a continuous process for preparing a liquid nutritional product using an extruder. To illustrate various aspects of the present disclosure, several exemplary embodiments of the continuous process are provided herein.

In one exemplary embodiment, a continuous process for preparing a liquid nutritional product is provided. The continuous process includes feeding a powder nutritional component into an inlet of an extruder and feeding a liquid component into an inlet of the extruder. The powder nutritional component and the liquid component are mixed within the extruder to form an intermediate nutritional blend. The intermediate nutritional blend is hydrated to form a liquid nutritional product.

In certain exemplary embodiments, the step of hydrating the intermediate nutritional blend comprises feeding water into a terminal inlet of the extruder. The intermediate nutritional blend and the water fed into the terminal inlet of the extruder are mixed within the extruder to form the liquid nutritional product.

In certain exemplary embodiments, after the intermediate nutritional blend is formed within the extruder, the intermediate nutritional blend is transferred to a mixer in fluid communication with an outlet of the extruder. The intermediate nutritional blend is hydrated by feeding water into the mixer, and the intermediate nutritional blend and the water are mixed within the mixer to form the liquid nutritional product.

In one exemplary embodiment, a continuous process for preparing a packaged liquid nutritional product is provided. The continuous process includes feeding a powder nutritional component selected from a protein, a carbohydrate, a fat, and combinations thereof into one or more inlets of an extruder, and feeding a liquid component selected from water, an oil blend, and combinations thereof into one or more inlets of the extruder. The powder nutritional component and the liquid component are mixed within the extruder to form an intermediate nutritional blend. Subsequently, the intermediate nutritional blend is transferred to a mixer in fluid communication with an outlet of the extruder. Water is fed into the mixer and the intermediate nutritional blend and the water are mixed to form a liquid nutritional product. The liquid nutritional product is transferred to a liquid filling system in fluid communication with an outlet of the mixer, and the liquid filing system dispenses a predetermined volume of the liquid nutritional product into a container. The container is sealed to form a packaged liquid nutritional product.

In certain exemplary embodiments, the continuous process for preparing a packaged nutritional product includes homogenizing the liquid nutritional product and sterilizing the nutritional product prior to transferring the liquid nutritional product to the liquid filling system.

### BRIEF DESCRIPTION OF THE DRAWINGS

FIG. 1 is a schematic diagram of an embodiment of a continuous process for preparing a liquid nutritional product as described herein.

FIG. 2 is a schematic diagram of an embodiment of a continuous process for preparing a liquid nutritional product as described herein.

### DETAILED DESCRIPTION

Disclosed herein is a continuous process for preparing a liquid nutritional product using an extruder. While the present disclosure describes certain embodiments of the continuous process in detail, the present disclosure is to be considered exemplary and is not intended to be limited to the disclosed embodiments.

The terminology as set forth herein is for description of the embodiments only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

The continuous process for preparing a liquid nutritional product using an extruder as described in the present disclosure can comprise, consist of, or consist essentially of the essential elements of the disclosure as described herein, as well as any additional or optional element described herein or which is otherwise useful in processes for preparing liquid nutritional products.

All percentages, parts, and ratios as used herein are by weight of the total formulation, unless otherwise specified. All such weights as they pertain to listed ingredients are based on the active level and, therefore, do not include solvents or by-products that may be included in commercially available materials, unless otherwise specified.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

Any combination of method or process steps as used herein may be performed in any order, unless otherwise specified or clearly implied to the contrary by the context in which the referenced combination is made.

The term “liquid nutritional product” as used herein, unless otherwise specified, refers to a nutritional product in ready-to-drink liquid form or concentrated liquid form. The liquid nutritional product generally includes at least one of a protein, a carbohydrate, and a fat. In certain exemplary embodiments, the liquid nutritional product is an oil-in-water emulsion.

The term “powder nutritional component” as used herein, unless otherwise specified, refers to a nutritional component such as a protein, a carbohydrate, a fat, vitamins, or minerals in the form of a free flowing solid product including, but not limited to, powder, dust, fine grains, loose particles, agglomerates, granules, and so forth.

The term “intermediate nutritional blend” as used herein, unless otherwise specified, refers to a paste-like mixture formed within the extruder. The intermediate nutritional blend undergoes additional processing to form the liquid nutritional product.

The terms “fat” and “oil” as used herein, unless otherwise specified, are used interchangeably to refer to lipid materials derived or processed from plants or animals. These terms also include synthetic lipid materials so long as such synthetic materials are suitable for human consumption.

The term “continuous process” as used herein, unless otherwise specified, refers to a process in which, once the process has been established, ingredients for preparing a liquid nutritional product are constantly fed to an extruder and the final liquid nutritional product is simultaneously removed. In other words, the inputs and the outputs of the process flow continuously throughout the duration of the process. The continuous process operates to convert a substantially continuous stream of ingredients into a substantially continuous stream of liquid nutritional product. The term “substantially continuous” when referring to the feeding of ingredients, removal of liquid nutritional product, or other operations (such as homogenization, sterilization, etc.) performed as a part of the process mean that the operation is carried out over a period of time during the course of the process, in contrast to batch-wise or periodic performance of such operations. The terms are not meant, however, to exclude the possibility of periodic interruption in the process.

The exemplary embodiments of the continuous process for preparing a liquid nutritional product described herein utilize an extruder. Any suitable extruder known for use in the nutritional arts may be used in accordance with the embodiments of the continuous process of the present disclosure. For example, in certain exemplary embodiments, the extruder may be a single screw extruder, multi screw extruder, ring screw extruder, planetary gear extruder, and the like.

In certain exemplary embodiments, the continuous process for preparing a liquid nutritional product uses a co-rotating, twin screw extruder. Generally, twin screw extruders comprise a barrel having one or more inlets for adding ingredients, two screws, and a die or other outlet. The extruder screws are positioned inside of the barrel and may comprise a wide variety of functional elements including, but not limited to, shear elements, mixing elements, homogenizing elements, conveying elements, kneading elements, emulsifying elements, disc elements, or any combination of the foregoing in any interchangeable order. The barrel of the extruder may comprise a number of segments that are bolted, clamped, or otherwise joined together. The barrel or barrel segments may be jacketed to permit indirect, controlled heating or cooling of the material being processed within the extruder. In addition, the barrel or barrel segments may include one or more inlets for adding ingredients into the extruder. The extruder also includes one or more outlets to allow the material within the extruder to flow out of the extruder.

The use of an extruder in the continuous process for preparing a liquid nutritional product disclosed herein has a number of advantages over conventional processes. For example, the extruder eliminates the need for preparing and then combining multiple slurries or blends since the extruder can homogenously disperse and mix together all of the ingredients that make up the liquid nutritional product. In other words, the extruder condenses the process into one unit operation as compared to the multiple unit operations required in conventional processes. Along the same lines, using an extruder permits the process to operate in a continuous manner because all of the ingredients can be continuously fed into the extruder, as opposed to conventional batch processes. In addition, the extruder allows for increased automation, which enables greater process control. Furthermore, the extruder can be used to sterilize the liquid nutritional product via thermal treatment, thus avoiding the added cost of a separate sterilization system. Moreover, the extruder can be used to process highly viscous materials, which is not typically possible in conventional processes that utilize separate homogenization and sterilization systems. Ultimately, using an extruder to prepare the liquid nutritional product lowers production costs by utilizing less energy and less equipment.

In one exemplary embodiment, a continuous process for preparing a liquid nutritional product includes feeding a powder nutritional component into an inlet of an extruder and feeding a liquid component into an inlet of the extruder. The powder nutritional component and the liquid component are mixed within the extruder to form an intermediate nutritional blend. The intermediate nutritional blend is hydrated to form a liquid nutritional product.

The powder nutritional component may be fed into an inlet of the extruder by a variety of techniques including, but not limited to, gravity feeding from a hopper, pumping from a storage tank, and the like. In certain embodiments, the powder nutritional component is fed into an inlet positioned within the first three-quarters of the length of the extruder. It should be understood that the powder nutritional component may be fed into one or more than one inlet of the extruder. In certain embodiments, the powder nutritional component comprises at least one of a protein, a carbohydrate, and a fat. In certain embodiments, the powder nutritional component comprises a protein and a carbohydrate. In those embodiments where the powder nutritional component comprises multiple powder nutritional components, each powder nutritional component may be fed into a separate inlet of the extruder. Alternatively, the individual powder nutritional components may be fed into one common inlet of the extruder, or may be fed into multiple inlets of the extruder with any combination of the individual powder nutritional components.

The liquid component may be fed into an inlet of the extruder by a variety of techniques including, but not limited to, gravity feeding from a hopper, pumping from a storage tank, and the like. In certain embodiments, the liquid component is fed into an inlet positioned within the first three-quarters of the length of the extruder. It should be understood that the liquid component may be fed into one or more than one inlet of the extruder. In certain embodiments, the liquid component comprises at least one of water and an oil blend. The term “oil blend” as used herein refers to a single oil or fat, or a mixture comprising multiple oils or fats. In certain embodiments, the liquid component comprises water including a water-soluble vitamin. In certain embodiments, the liquid component comprises an oil blend comprising at least one fat and an oil-soluble vitamin. In certain embodiments, the liquid component may be preheated to a temperature of about 35° C. to about 90° C. prior to being fed into the extruder. For example, in certain embodiments, the oil blend may be preheated to a temperature above the melting point of the fat to render a liquid. In those embodiments where the liquid component includes both water and an oil blend, the water and the oil blend may be fed into separate inlets of the extruder. Alternatively, the water and the oil blend may be fed into one common inlet of the extruder, or may be fed into multiple inlets of the extruder.

In certain embodiments, the powder nutritional component is fed into an inlet of the extruder that is upstream of the inlet where the liquid component is fed into the extruder. In certain embodiments, the liquid component is fed into an inlet of the extruder that is upstream of the inlet where the powder nutritional component is fed into the extruder. When fed into the extruder, the powder nutritional component and the liquid component are mixed within the extruder to form an intermediate nutritional blend. As mentioned above, the intermediate nutritional blend is a paste-like mixture. In certain embodiments, the intermediate nutritional blend has a solids content of about 25 wt % to about 98 wt %, including about 30 wt % to about 98 wt %, about 40 wt % to about 98 wt %, about 50 wt % to about 98 wt %, about 55 wt % to about 95 wt %, about 60 wt % to about 90 wt %, about 70 wt % to about 85 wt %, about 75 wt % to about 85 wt %, about 80 wt % to about 95 wt %, or about 90 wt % to about 98 wt %. The particular solids content of the intermediate nutritional blend can be selected based upon the type of liquid nutritional product being produced, such as a concentrated liquid nutritional product or a liquid nutritional emulsion.

The mixing of the powder nutritional component and the liquid component within the extruder may be carried out at various temperatures and pressures. In certain embodiments, the powder nutritional component and the liquid component are mixed within the extruder at a temperature of about 20° C. to about 200° C., including about 20° C. to about 190° C., about 20° C. to about 180° C., about 25° C. to about 170° C., about 30° C. to about 160° C., about 30° C. to about 150° C., about 30° C. to about 130° C., about 40° C. to about 100° C., about 50° C. to about 90° C., or about 60° C. to about 80° C. In certain embodiments, the powder nutritional component and the liquid component are mixed within the extruder at a variable pressure of about 0 bar to about 700 bar, including about 10 bar to about 700 bar, about 50 bar to about 700 bar, about 100 bar to about 600 bar, about 200 bar to about 500 bar, or about 300 bar to about 400 bar. In certain embodiments, the temperature at which the powder nutritional component and the liquid component are mixed within the extruder may be varied. As mentioned above, the extruder may comprise multiple barrel segments, and each barrel segment may be configured with appropriate heating and cooling controls to maintain a predetermined temperature within the barrel segment. By way of example only, a first barrel of the extruder may be configured to maintain a temperature of 50° C., a second barrel of the extruder may be configured to maintain a temperature of 60° C., and a third barrel of the extruder may be configured to maintain a temperature of 70° C.

The processing of the components within the extruder may be carried out at various residence times. For example, in certain embodiments, the components fed into the extruder are processed within the extruder for about 5 minutes to about 20 minutes, including about 5 minutes to about 18 minutes, about 5 minutes to about 15 minutes, about 5 minutes to about 10 minutes, about 10 minutes to about 20 minutes, or about 15 minutes to about 20 minutes.

In accordance with the continuous process disclosed herein, the intermediate nutritional blend is hydrated to form the liquid nutritional product. Accordingly, water is added to and mixed with the intermediate nutritional blend to form the liquid nutritional product. In certain embodiments, an amount of water is added to the intermediate nutritional blend such that the liquid nutritional product has a water content of about 30 wt % to about 98 wt %, including about 40 wt % to about 90 wt %, about 50 wt % to about 85 wt %, about 60 wt % to about 80 wt %, about 65 wt % to about 75 wt %, about 70 wt % to about 90 wt %, or about 75 wt % to about 98 wt %. The water content of the liquid nutritional product will typically depend on the type of liquid nutritional product being produced. For example, in certain embodiments, the liquid nutritional product is a concentrated liquid nutritional product having a water content of about 30 wt % to about 70 wt % and a solids content of about 30 wt % to about 70 wt % In certain embodiments, the concentrated liquid nutritional product has a water content of about 35 wt % to about 70 wt %, including about 40 wt % to about 65 wt %, about 45 wt % to about 60 wt %, about 50 wt % to about 55 wt %, or about 55 wt % to about 70 wt % Similarly, in certain embodiments, the concentrated liquid nutritional product has a solids content of about 30 wt % to about 65 wt %, including about 35 wt % to about 60 wt %, about 40 wt % to about 55 wt %, about 45 wt % to about 50 wt %, or about 30 wt % to about 45 wt %.

In certain embodiments of the continuous process disclosed herein, the intermediate nutritional blend is hydrated by feeding water into a terminal inlet of the extruder. As water is fed into the terminal inlet of the extruder, the intermediate nutritional blend and the water are mixed within the extruder to form the liquid nutritional product. The water may be fed into a terminal inlet of the extruder by a variety of techniques including, but not limited to, gravity feeding from a hopper, pumping from a storage tank, and the like. The term “terminal inlet” as used herein, refers to an inlet that is downstream of all other inlets through which ingredients are fed into the extruder. In certain embodiments, the terminal inlet is positioned within the last quarter of the length of the extruder. The amount of water fed into a terminal inlet of the extruder may be controlled such that the liquid nutritional product exiting the extruder has the desired water content and solids content, for example, a water content of about 30 wt % to about 95 wt % and a solids content of about 5 wt % to about 70 wt %.

In certain embodiments of the continuous process disclosed herein, the liquid nutritional product is homogenized, sterilized, or both within the extruder. For example, in certain embodiments, the extruder may include extruder screws that comprise functional elements configured to homogenize the liquid nutritional product prior to exiting the extruder. In certain embodiments, the extruder may include one or more barrel segments configured to sterilize the liquid nutritional product within the extruder. For example, in certain embodiments, the extruder may comprise at least one jacketed barrel segment such that the liquid nutritional product being conveyed therethrough is subjected to a sufficient temperature for a sufficient time to sterilize the liquid nutritional product. In certain embodiments, the liquid nutritional product is subjected to a temperature of about 120° C. to about 150° C. for about 5 seconds to sterilize the liquid nutritional product prior to exiting the extruder.

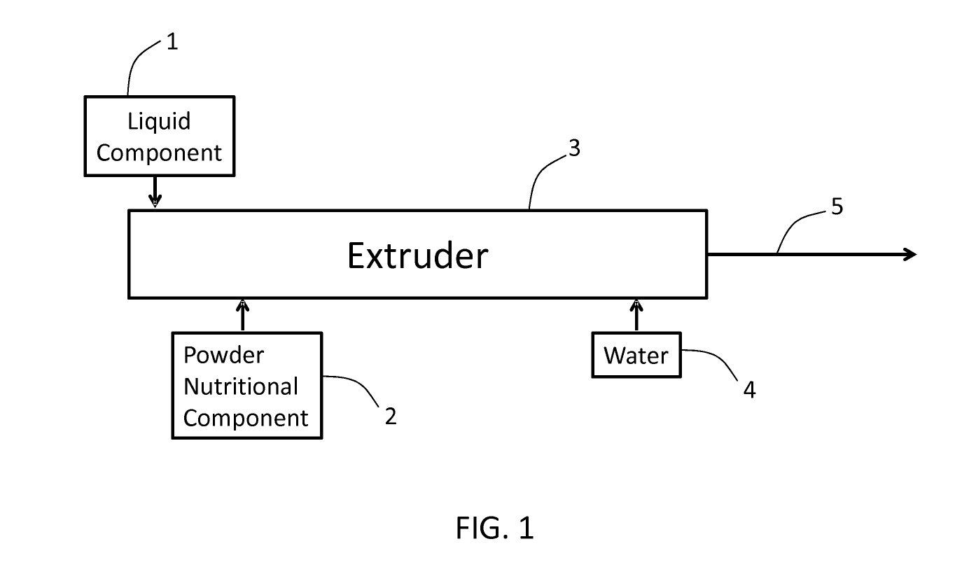

Referring now to FIG. 1, an embodiment of a continuous process for preparing a liquid nutritional product is shown. In this particular embodiment, a liquid component (1) and a powder nutritional component (2) are fed into an extruder (3). The liquid component (1) and the powder nutritional component (2) are mixed within the extruder (3) to form an intermediate nutritional blend. Water (4) is fed into a terminal inlet of the extruder where it is mixed with the intermediate nutritional blend to hydrate the intermediate nutritional blend and thereby form the liquid nutritional product (5). As discussed in detail below, in certain embodiments, the liquid nutritional product (5) exiting the extruder may be homogenized, sterilized, or both, and may also be packaged or collected and stored in a product storage tank for packaging at a later time.

In certain embodiments, the liquid nutritional product exiting the extruder is packaged. For example, in certain embodiments, an outlet of the extruder is in fluid communication with a liquid filling system, which may include a product tank that holds the liquid nutritional product prior to the liquid filling system dispensing a predetermined volume of the liquid nutritional product into a container. The liquid nutritional product may be transferred from an outlet of the extruder to the liquid filling system by a variety of techniques including, but not limited to, gravity feeding, pumping, and the like. Liquid filling systems are well known in the art, and a wide variety of conventional liquid filling systems may be used in the embodiments of the continuous process described herein. After a predetermined volume of the liquid nutritional product is dispensed into a container, the container is sealed or otherwise closed to form a packaged liquid nutritional product. Container sealing or capping systems are well known in the art, and a wide variety of conventional container sealing or capping systems may be used in the embodiments of the continuous process described herein. The liquid nutritional product may be sterilized prior to packaging (e.g., aseptic process, hot fill process) or after packaging (e.g., retort process).

In certain embodiments, the liquid nutritional product exiting the extruder is homogenized, sterilized, or both prior to the liquid nutritional product being packaged. For example, in certain embodiments, an outlet of the extruder is in fluid communication with a homogenizer. In certain embodiments, a homogenizer is used to reduce the globule or particle size of the liquid nutritional product to provide a homogeneous, uniform product. It should be understood that homogenization may be achieved using either a one stage or a two stage homogenization technique. For example, in a two stage homogenization system, the liquid nutritional product may be subjected to a first stage homogenization pressure of about 5,000 psig and then subjected to a second stage homogenization pressure of about 500 psig. In certain embodiments, an outlet of the homogenizer is in fluid communication with a sterilization system. In certain embodiments, an outlet of the extruder is in fluid communication with a sterilization system. The sterilization system ensures that microorganisms are destroyed or reduced to an acceptable level in the liquid nutritional product. The sterilization system may be any of a wide variety of systems known to those of skill in the art including, but not limited to, a thermal treatment system (e.g., a high-temperature, short-time (HTST) system, an ultra-high temperature (UHT) system), a high pressure treatment system, an ultraviolet (UV) treatment system, or any other suitable sterilization technology, now known or known in the future. The particular conditions for carrying out the sterilization are typically product dependent, but by way of example may include subjecting the liquid nutritional product to a temperature of about 120° C. to about 150° C. for about 5 seconds.

In certain embodiments, an outlet of the sterilization system is in fluid communication with a liquid filling system, which may include a product tank that holds the sterilized liquid nutritional product prior to the liquid filling system dispensing a predetermined volume of the sterilized liquid nutritional product into a container. In certain embodiments, the container is sterilized prior to the predetermined volume of sterilized liquid nutritional product being dispensed into the container. For example, the container may be sterilized using a hydrogen peroxide treatment method. The sterilized container filled with the sterilized liquid nutritional product may then be sealed to form the packaged liquid nutritional product. In certain embodiments, the container is sterilized from the heat of the sterilized liquid nutritional product being dispensed into the container. The container filled with the hot sterilized liquid nutritional product may then be sealed to form the packaged liquid nutritional product, which may then be flipped or tilted to complete the sterilization of the container. In the preceding embodiments, the liquid nutritional product may be transferred to and from the various processing systems utilizing conventional means, such as gravity feeding, pumping, and the like.

In certain embodiments of the continuous process disclosed herein, the intermediate nutritional blend is hydrated by transferring the intermediate nutritional blend to a mixer in fluid communication with an outlet of the extruder. The intermediate nutritional blend can be transferred from the extruder to the mixer in a variety of ways. For example, the intermediate nutritional blend can be pumped or gravity fed into the mixer. In certain embodiments, the mixer is an inline mixer. The inline mixer may be a static mixer (with no moving parts), a high-shear mixer (with moving parts), or simply a piping joint that creates enough turbulence to mix the water and the intermediate nutritional blend. In certain embodiments, the mixer is one or more mixing tanks Water is fed into the mixer along with the intermediate nutritional blend, and the intermediate nutritional blend and the water are mixed within the mixer to form the liquid nutritional product. The amount of water fed into the mixer may be controlled such that the liquid nutritional product exiting the mixer has the desired water content and solids content, for example, a water content of about 30 wt % to about 98 wt % and a solids content of about 2 wt % to about 70 wt %.

In certain embodiments, the liquid nutritional product exiting the mixer is packaged. For example, in certain embodiments, an outlet of the mixer is in fluid communication with a liquid filling system, which may include a product tank that holds the liquid nutritional product prior to the liquid filling system dispensing a predetermined volume of the liquid nutritional product into a container. The liquid nutritional product may be transferred from an outlet of the mixer to the liquid filling system by a variety of techniques including, but not limited to, gravity feeding, pumping, and the like. After a predetermined volume of the liquid nutritional product is dispensed into a container, the container is sealed or otherwise closed to form a packaged liquid nutritional product. The liquid nutritional product may be sterilized prior to packaging (e.g., aseptic process, hot fill process) or after packaging (e.g., retort process).

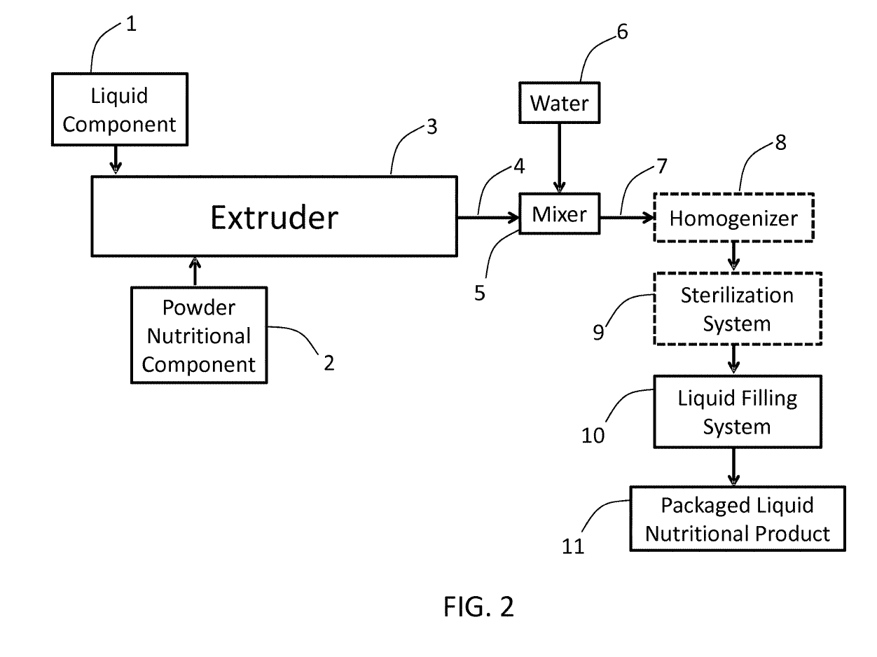

Referring now to FIG. 2, an embodiment of a continuous process for preparing a packaged liquid nutritional product is shown. In this particular embodiment, a liquid component (1) and a powder nutritional component (2) are fed into an extruder (3). The liquid component (1) and the powder nutritional component (2) are mixed within the extruder (3) to form an intermediate nutritional blend (4). The intermediate nutritional blend (4) is transferred from the extruder (3) to a mixer (5). Water (6) is fed into the mixer (5) where it is mixed with the intermediate nutritional blend (4) to hydrate the intermediate nutritional blend (4) and thereby form the liquid nutritional product (7). As discussed in detail below, in certain embodiments, the liquid nutritional product (7) exiting the mixer may optionally be processed (as noted by the dashed boxes) in a homogenizer (8), a sterilization system (9), or both prior to packaging. The liquid nutritional product (7) is transferred to a liquid filling system (10) that dispenses a predetermined volume of the liquid nutritional product (7) into a container, which is subsequently sealed or otherwise closed to form a packaged liquid nutritional product (11).

In certain embodiments, the liquid nutritional product exiting the mixer is homogenized, sterilized, or both prior to the liquid nutritional product being packaged. For example, in certain embodiments, an outlet of the mixer is in fluid communication with a homogenizer. In certain embodiments, a homogenizer is used to reduce the globule or particle size of the liquid nutritional product to provide a homogeneous, uniform product. In certain embodiments, an outlet of the homogenizer is in fluid communication with a sterilization system. In certain embodiments, an outlet of the mixer is in fluid communication with a sterilization system. The sterilization system may be any of the previously described systems. In certain embodiments, an outlet of the sterilization system is in fluid communication with a liquid filling system, which may include a product tank that holds the liquid nutritional product prior to the liquid filling system dispensing a predetermined volume of the liquid nutritional product into a container. In the preceding embodiments, the liquid nutritional product may be transferred to and from the various processing systems utilizing conventional means, such as gravity feeding, pumping, and the like.

In one exemplary embodiment, a continuous process for preparing a packaged liquid nutritional product is provided. The continuous process includes feeding a powder nutritional component selected from a protein, a carbohydrate, a fat, and combinations thereof into one or more inlets of an extruder, and feeding a liquid component selected from water, an oil blend, and combinations thereof into one or more inlets of the extruder. The powder nutritional component and the liquid component are mixed within the extruder to form an intermediate nutritional blend. Water is fed into a terminal inlet of the extruder, and the intermediate nutritional blend and the water are mixed within the extruder to form a liquid nutritional product. The liquid nutritional product is transferred to a liquid filling system in fluid communication with an outlet of the extruder, and the liquid filing system dispenses a predetermined volume of the liquid nutritional product into a container. The container is sealed to form a packaged liquid nutritional product. Any of the previously described processing techniques and equipment may also be used in this particular embodiment. In certain embodiments, the continuous process for preparing a packaged liquid nutritional product includes homogenizing the liquid nutritional product, sterilizing the liquid nutritional product, or both prior to the liquid nutritional product being packaged. In certain embodiments, the packaged liquid nutritional product is sterilized using a retort process. The homogenization or sterilization of the liquid nutritional product may be carried out as previously described.

In one exemplary embodiment, a continuous process for preparing a packaged liquid nutritional product is provided. The continuous process includes feeding a powder nutritional component selected from a protein, a carbohydrate, a fat, and combinations thereof into one or more inlets of an extruder, and feeding a liquid component selected from water, an oil blend, and combinations thereof into one or more inlets of the extruder. The powder nutritional component and the liquid component are mixed within the extruder to form an intermediate nutritional blend. Subsequently, the intermediate nutritional blend is transferred to a mixer in fluid communication with an outlet of the extruder. Water is fed into the mixer and the intermediate nutritional blend and the water are mixed to form a liquid nutritional product. The liquid nutritional product is transferred to a liquid filling system in fluid communication with an outlet of the mixer, and the liquid filing system dispenses a predetermined volume of the liquid nutritional product into a container. The container is sealed to form a packaged liquid nutritional product. Any of the previously described processing techniques and equipment may also be used in this particular embodiment. In certain embodiments, the continuous process for preparing a packaged liquid nutritional product includes homogenizing the liquid nutritional product, sterilizing the liquid nutritional product, or both prior to the liquid nutritional product being packaged. In certain embodiments, the packaged liquid nutritional product is sterilized using a retort process. The homogenization or sterilization of the liquid nutritional product may be carried out as previously described.

As mentioned above, in certain embodiments, the powder nutritional component comprises at least one of a protein, a carbohydrate, and a fat. In certain embodiments, the powder nutritional component comprises a protein and a carbohydrate. A wide variety of protein sources, carbohydrate sources, and fat sources may be used in the various embodiments of the continuous process for preparing a liquid nutritional product described herein.

In certain embodiments, the powder nutritional component comprises a protein. Any source of protein may be used so long as it is suitable for use in liquid nutritional products and is otherwise compatible with any other selected ingredients or features in the liquid nutritional product. For example, the protein may include, but is not limited to, intact, hydrolyzed, or partially hydrolyzed protein, which may be derived from any known or otherwise suitable source such as milk (e.g., casein, whey), animal (e.g., meat, fish), cereal (e.g., rice, corn), vegetable (e.g., soy, pea), and combinations thereof. The protein may also include a mixture of amino acids (often described as free amino acids) or a combination of such amino acids with the intact, hydrolyzed, or partially hydrolyzed proteins described herein. The amino acids may be naturally occurring or synthetic amino acids.

More particular examples of suitable sources of protein for use as a powder nutritional component in the embodiments of the continuous process disclosed herein include, but are not limited to, whole cow's milk, partially or completely defatted milk, milk protein concentrates, milk protein isolates, nonfat dry milk, condensed skim milk, whey protein concentrates, whey protein isolates, acid caseins, sodium caseinates, calcium caseinates, potassium caseinates, legume protein, soy protein concentrates, soy protein isolates, pea protein concentrates, pea protein isolates, collagen proteins, potato proteins, rice proteins, wheat proteins, canola proteins, quinoa, insect proteins, earthworm proteins, fungal (e.g., mushroom) proteins, hydrolyzed yeast, gelatin, bovine colostrum, human colostrum, glycomacropeptides, mycoproteins, proteins expressed by microorganisms (e.g., bacteria and algae), and combinations thereof. The powder nutritional component, and hence the liquid nutritional product described herein, may include any individual source of protein or combination of the various sources of protein listed above.

In certain embodiments, the powder nutritional component comprises a carbohydrate. The carbohydrate or source of carbohydrate suitable for use as a powder nutritional component in the embodiments of the continuous process disclosed herein may be simple, complex, or variations or combinations thereof. Generally, the carbohydrate may include any carbohydrate or carbohydrate source that is suitable for use in liquid nutritional products and is otherwise compatible with any other selected ingredients or features in the liquid nutritional product.

Non-limiting examples of carbohydrates (or sources thereof) suitable for use as a powder nutritional component in the embodiments of the continuous process disclosed herein include, but are not limited to, polydextrose, maltodextrin; hydrolyzed or modified starch or cornstarch; glucose polymers; corn syrup; corn syrup solids; rice-derived carbohydrate; sucrose; glucose; fructose; lactose; honey; sugar alcohols (e.g., maltitol, erythritol, sorbitol); isomaltulose; sucromalt; pullulan; potato starch; and other slowly-digested carbohydrates; dietary fibers including, but not limited to, fructooligosaccharides (FOS), galactooligosaccharides (GOS), oat fiber, soy fiber, gum arabic, sodium carboxymethylcellulose, methylcellulose, guar gum, gellan gum, locust bean gum, konjac flour, hydroxypropyl methylcellulose, tragacanth gum, karaya gum, gum acacia, chitosan, arabinoglactins, glucomannan, xanthan gum, alginate, pectin, low methoxy pectin, high methoxy pectin, cereal beta-glucans (e.g., oat beta-glucan, barley beta-glucan), carrageenan and psyllium, digestion resistant maltodextrin (e.g., Fibersol™, a digestion-resistant maltodextrin including soluble dietary fiber); soluble and insoluble fibers derived from fruits or vegetables; other resistant starches; and combinations thereof. The powder nutritional component, and hence the liquid nutritional product described herein, may include any individual source of carbohydrate or combination of the various sources of carbohydrate listed above.

In certain embodiments, the powder nutritional component comprises a fat. The fat or source of fat suitable for use as a powder nutritional component in the embodiments of the continuous process disclosed herein may be derived from various sources including, but not limited to, plants, animals, and combinations thereof. Generally, the fat may include any fat or fat source that is suitable for use in liquid nutritional products and is otherwise compatible with any other selected ingredients or features in the liquid nutritional product. In addition, when the fat or source of fat is in powder form, the fat will typically be present with some amount of carbohydrate (e.g., maltodextrin), protein, or both.

Non-limiting examples of suitable fat (or sources thereof) for use as a powder nutritional component in the embodiments of the continuous process disclosed herein include, but are not limited to, powdered coconut oil, powdered fractionated coconut oil, powdered soy oil, powdered high oleic soy oil, powdered corn oil, powdered olive oil, powdered safflower oil, powdered high oleic safflower oil, powdered medium chain triglyceride oil (MCT oil), powdered high gamma linolenic (GLA) safflower oil, powdered sunflower oil, powdered high oleic sunflower oil, powdered palm oil, powdered palm kernel oil, powdered canola oil, powdered high oleic canola oil, powdered marine oils, powdered fish oils, powdered algal oils, powdered borage oil, powdered cottonseed oil, powdered fungal oils, powdered eicosapentaenoic acid (EPA), powdered docosahexaenoic acid (DHA), powdered arachidonic acid (ARA), powdered conjugated linoleic acid (CLA), powdered alpha-linolenic acid (ALA), powdered rice bran oil, powdered wheat bran oil, and combinations thereof. The powder nutritional component, and hence the liquid nutritional product described herein, may include any individual source of fat or combination of the various sources of fat listed above.

The continuous process for preparing a liquid nutritional product also includes a liquid component that is fed into one or more inlets of the extruder to form the intermediate nutritional blend. In certain embodiments, the liquid component is selected from water, an oil blend, and combinations thereof.

In certain embodiments, the liquid component comprises water. In certain embodiments, the water includes a water-soluble vitamin. For example, one or more water-soluble vitamins can be added to the water prior to the water being fed into the extruder. Exemplary water-soluble vitamins include thiamine, riboflavin, pyridoxine, vitamin B₁₂, niacin, folic acid, pantothenic acid, biotin, vitamin C, salts and derivatives thereof, and combinations thereof

In certain embodiments, the liquid component comprises an oil blend. The oil blend may include one fat or may comprise a mixture of different fats. Non-limiting examples of suitable fat (or sources thereof) for use as a liquid component in the embodiments of the continuous process disclosed herein include, but are not limited to, coconut oil, fractionated coconut oil, soy oil, high oleic soy oil, corn oil, olive oil, safflower oil, high oleic safflower oil, medium chain triglyceride oil (MCT oil), high gamma linolenic (GLA) safflower oil, sunflower oil, high oleic sunflower oil, palm oil, palm kernel oil, palm olein, canola oil, high oleic canola oil, marine oils, fish oils, algal oils, borage oil, cottonseed oil, fungal oils, eicosapentaenoic acid (EPA), docosahexaenoic acid (DHA), arachidonic acid (ARA), conjugated linoleic acid (CLA), alpha-linolenic acid, rice bran oil, wheat bran oil, interesterified oils, transesterified oils, structured lipids, and combinations thereof

In certain embodiments, the liquid component comprises an oil blend comprising at least one fat and an oil-soluble vitamin. For example, the oil blend can be a mixture of one or more of the fats listed above and one or more oil-soluble vitamins. Exemplary oil-soluble vitamins include various forms of vitamin A, vitamin D, vitamin E, vitamin K, and combinations thereof

The continuous process for preparing a liquid nutritional product may also include the addition of optional components that may modify the physical, chemical, aesthetic, or processing characteristics of the liquid nutritional product or serve as additional nutritional components when used for a targeted population. Many such optional ingredients are known or otherwise suitable for use in other nutritional products and may also be used in the continuous process described herein, provided that such optional ingredients are safe and effective for oral consumption and are compatible with the essential ingredients and other ingredients as described herein.

Non-limiting examples of such optional ingredients include preservatives, antioxidants, emulsifying agents, buffers, pharmaceutical actives, additional nutrients as described herein, sweeteners including artificial sweeteners (e.g., saccharine, aspartame, acesulfame K, sucralose), colorants, flavors (artificial, natural, or both), thickening agents, stabilizers, and so forth. Such optional ingredients may be fed into one or more inlets of the extruder, and may be fed into the extruder in powder or liquid form depending on the particular ingredient.

In certain embodiments, the continuous process for preparing a liquid nutritional product may further comprise the addition of any of a variety of vitamins or related nutrients, non-limiting examples of which include vitamin A, vitamin D, vitamin E, vitamin K, thiamine, riboflavin, pyridoxine, vitamin B₁₂, carotenoids, niacin, folic acid, pantothenic acid, biotin, vitamin C, choline, inositol, salts and derivatives thereof, and combinations thereof.

In certain embodiments, the continuous process for preparing a liquid nutritional product may further comprise the addition of any of a variety of minerals, non-limiting examples of which include calcium, phosphorus, magnesium, iron, zinc, manganese, copper, sodium, potassium, molybdenum, chromium, chloride, and combinations thereof

The liquid nutritional products prepared according to the continuous process disclosed herein may include a variety of product forms for use by a targeted population. For example, the liquid nutritional product may be a ready-to-drink or ready-to-feed liquid product, or a concentrated liquid product that is intended to be diluted with another liquid (typically water) prior to drinking or feeding. Specific non-limiting examples of liquid nutritional products include liquid and concentrated liquid adult nutritional compositions, liquid and concentrated liquid human milk fortifiers, liquid and concentrated liquid preterm infant formulas, liquid and concentrated liquid infant formulas, liquid and concentrated liquid pediatric formulas, liquid and concentrated liquid toddler formulas, and liquid and concentrated liquid follow-on formulas.

As previously mentioned, in certain embodiments, the liquid nutritional product prepared by the continuous process disclosed herein include protein, carbohydrate, and fat, as well as vitamins, minerals, and other nutrients. In general, the total concentrations or amounts of the total protein, carbohydrates, and fat will vary depending upon the product form (e.g., ready-to-drink liquid, concentrated liquid) as well as the targeted dietary needs of the intended consumer (e.g., preterm infant, infant, toddler, child, adult).

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use.

Unless otherwise indicated herein, all sub-embodiments and optional embodiments are respective sub-embodiments and optional embodiments to all embodiments described herein. While the present application has been illustrated by the description of embodiments thereof, and while the embodiments have been described in considerable detail, it is not the intention of the Applicant to restrict or in any way limit the scope of the appended claims to such detail. Additional advantages and modifications will readily appear to those skilled in the art. Therefore, the application, in its broader aspects, is not limited to the specific details, the representative compositions or formulations, and illustrative examples shown and described. Accordingly, departures may be made from such details without departing from the spirit or scope of the general disclosure described herein.

1. A continuous process for preparing a liquid nutritional product comprising:
a) feeding a powder nutritional component into an inlet of an extruder;
b) feeding a liquid component into an inlet of the extruder;
c) mixing the powder nutritional component and the liquid component within the extruder to form an intermediate nutritional blend; and
d) hydrating the intermediate nutritional blend to form a liquid nutritional product.

2. The continuous process of claim 1, wherein step d) comprises feeding water into a terminal inlet of the extruder and mixing the intermediate nutritional blend and the water within the extruder to form the liquid nutritional product.

3. The continuous process of claim 1, wherein prior to step d) the intermediate nutritional blend is transferred to a mixer in fluid communication with an outlet of the extruder, and wherein step d) comprises feeding water into the mixer and mixing the intermediate nutritional blend and the water within the mixer to form the liquid nutritional product.

4. The continuous process of claim 1, wherein the powder nutritional component comprises at least one of a protein, a carbohydrate, and a fat.

5. (canceled)

6. The continuous process of claim 1, wherein the liquid component comprises at least one of water and an oil blend.

7. The continuous process of claim 1, wherein the liquid component comprises water including a water-soluble vitamin.

8. The continuous process of claim 1, wherein the liquid component comprises an oil blend comprising at least one fat and an oil-soluble vitamin.

9. The continuous process of claim 1, further comprising packaging the liquid nutritional product.

10. The continuous process of claim 9, further comprising homogenizing the liquid nutritional product and sterilizing the liquid nutritional product prior to packaging the liquid nutritional product.

11. The continuous process of claim 1, wherein the intermediate nutritional blend has a solids content of about 25 wt % to about 98 wt %.

12. The continuous process of claim 1, wherein the liquid nutritional product has a water content of about 30 wt % to about 98 wt %.

13. The continuous process of claim 1, wherein the liquid nutritional product is a concentrated liquid nutritional product having a solids content of about 30 wt % to about 70 wt %.

14.-15. (canceled).

16. A continuous process for preparing a packaged liquid nutritional product comprising:
a) feeding a powder nutritional component selected from a protein, a carbohydrate, a fat, and combinations thereof into one or more inlets of an extruder;
b) feeding a liquid component selected from water, an oil blend, and combinations thereof into one or more inlets of the extruder;
c) mixing the powder nutritional component and the liquid component within the extruder to form an intermediate nutritional blend;
d) transferring the intermediate nutritional blend to a mixer in fluid communication with an outlet of the extruder;
e) feeding water into the mixer and mixing the intermediate nutritional blend and the water to form a liquid nutritional product;
f) transferring the liquid nutritional product to a liquid filling system in fluid communication with an outlet of the mixer, wherein the liquid filling system dispenses a predetermined volume of the liquid nutritional product into a container; and
g) sealing the container to form a packaged liquid nutritional product.

17. The continuous process of claim 16, wherein the liquid component comprises water.

18. (canceled)

19. The continuous process of claim 16, wherein the liquid component comprises an oil blend comprising at least one fat and an oil-soluble vitamin.

20. The continuous process of claim 16, wherein the intermediate nutritional blend has a solids content of about 25 wt % to about 98 wt %.

21. The continuous process of claim 16, wherein the liquid nutritional product has a water content of about 30 wt % to about 98 wt %.

22. The continuous process of claim 16, wherein the liquid nutritional product is a concentrated liquid nutritional product having a solids content of about 30 wt % to about 70 wt %.

23. (canceled)

24. The continuous process of claim 16, further comprising homogenizing the liquid nutritional product and sterilizing the liquid nutritional product prior to transferring the liquid nutritional product to the liquid filling system.

25. The continuous process of claim 24, wherein the container is sterilized prior to the predetermined volume of the liquid nutritional product being dispensed into the container.
